(19) United States
(12) Patent Application Publication
(10) Pub. No.: US 2019/0052834 A1
(43) Pub. Date: Feb. 14, 2019

(54) RECEPTION DEVICE AND BROADCASTING SYSTEM

(71) Applicant: SHARP KABUSHIKI KAISHA, Sakai City, Osaka (JP)

(72) Inventors: TOMOO NISHIGAKI, Sakai City (JP); HIDEKI SUZUKI, Sakai City (JP)

(21) Appl. No.: 16/079,322

(22) PCT Filed: Feb. 14, 2017
(86) PCT No.: PCT/JP2017/005305

§ 371 Date: Aug. 23, 2018

(30) Foreign Application Priority Data
Mar. 17, 2016 (JP) 2016-054341

(51) Int. Cl. H04N 5/57; H04N 5/235; H04N 7/20

(52) U.S. Cl. CPC H04N 5/57; H04N 7/20; H04N 5/2355

(57) ABSTRACT

When a video of a program is determined as a high dynamic range video, which has a luminance range wider than a standard luminance range, on the basis of service information of the program, a display information output unit outputs a luminance setting screen that has an adjustment point related to predetermined subject luminance to be specified, a luminance setting unit sets target luminance of the adjustment point on the basis of an operation, and a luminance adjustment unit adjusts luminance of the adjustment point and luminance of the video on the basis of luminance adjustment information indicating the target luminance.

### TECHNICAL FIELD

An aspect of the present invention relates to a reception device and a broadcasting system.

This application claims priority based on Japanese Patent Application No. 2016-054341 filed in Japan on Mar. 17, 2016, the content of which is incorporated herein.

### BACKGROUND ART

As a part of enhancement in broadcasting, it is proposed to introduce video data capable of reproducing luminance in a range wider than an existing one. Such video data is specifically HDR. (High Dynamic Range; also referred to as a wide-band dynamic range) video data. The HDR video data is able to represent luminance in a significantly wide range compared to an existing SDR (Standard Dynamic Range) video signal that has been adopted. The HDR video data is expected to be operated with 4K/8K. resolution. in sophisticated broadband satellite broadcasting which starts in the future. The 4K/8K resolution is resolution in which the number of pixels of a video for one frame is 3840×2160 or 7680×4320.

Meanwhile, PTL 1 describes a video display device that adds in advance, to an image signal, information about existence of photosensitive property of a scene that induces photosensitive epilepsy, detects the information about existence of photosensitive property, and executes adjustment of light of a backlight unit on the basis of a light adjustment control signal according to a detection signal.

### CITATION LIST

### Patent Literature

PTL 1: Japanese Unexamined Patent Application Publication No. 2008-301150

### SUMMARY OF INVENTION

### Technical Problem

In the sophisticated broadband satellite broadcasting, a reception device displays a video having higher luminance that that of an existing SDR video, as an HDR video related to HDR video data that is transferred. There is a case where it is difficult for a user to expect a degree of brightness of the HDR video till when the user views the video. For example, when viewing the HDR video for the first time, the user feels that the video is too bright in some cases. Thus, an aspect of the invention aims to provide a reception device and a broadcasting system that allow a user to appropriately adjust luminance of an HDR video.

### Solution to Problem

An aspect of the invention is made to solve the aforementioned problems and an aspect of the invention is a reception device including: a display information output unit that, when a video of a program is determined as a high dynamic range video, which has a luminance range wider than a standard luminance range, on a basis of service information of the program, outputs a luminance setting screen that has an adjustment point related to predetermined subject luminance to be specified; a luminance setting unit that sets target luminance of the adjustment point on a basis of an operation; and a luminance adjustment unit that adjusts luminance of the adjustment point and luminance of the video on a basis of luminance adjustment information indicating the target luminance.

### Advantageous Effects of Invention

According to an embodiment of the invention, it is possible for a user to appropriately adjust luminance of an HDR video.

### BRIEF DESCRIPTION OF DRAWINGS

FIG. 1 is a schematic block diagram illustrating a configuration of a broadcasting system according to a first embodiment.

FIG. 2 is a schematic block diagram illustrating a configuration of a transmission device according to the first embodiment.

FIG. 3 is a schematic block diagram illustrating a configuration of a reception device according to the first embodiment.

FIG. 4 illustrates an example of a data structure of an MH-EIT according to the first embodiment.

FIG. 5 illustrates an example of a data structure of a video component descriptor according to the first embodiment.

FIG. 6 illustrates an example of a setting value of video signal transfer characteristics according to the first embodiment.

FIG. 7 illustrates an example of a luminance setting screen according to the first embodiment.

FIG. 8 illustrates another example of a luminance setting screen according to the first embodiment.

FIG. 9 illustrates an example of a luminance descriptor according to the first embodiment.

FIG. 10 is a schematic block diagram illustrating a configuration of a broadcasting system according to a second embodiment.

FIG. 11 is a schematic block diagram illustrating a configuration of a reception device according to the second embodiment.

FIG. 12 illustrates an example of application control according to the second embodiment.

FIG. 13 illustrates an execution example of an application according to the second embodiment.

### DESCRIPTION OF EMBODIMENTS

Hereinafter, embodiments of the invention will be described with reference to the drawings.

### First Embodiment

First, an outline of a broadcasting system 1 according to a first embodiment of the invention will be described.

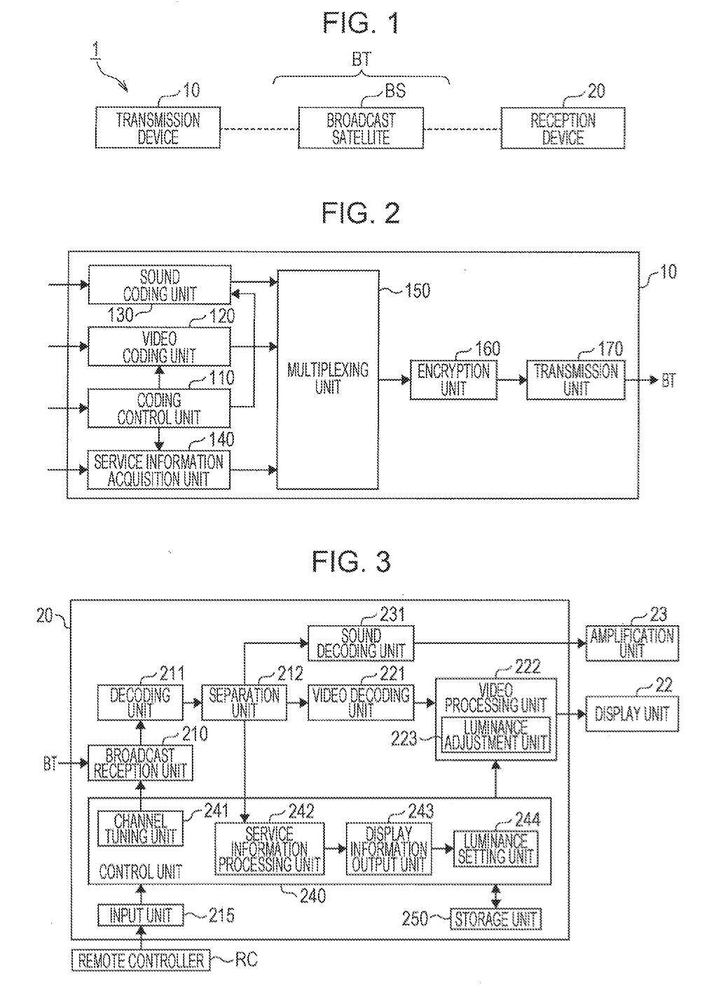

FIG. 1 is a schematic block diagram illustrating a configuration of the broadcasting system. I according to the present embodiment.

The broadcasting system 1 is configured by including a transmission device 10 and a reception device 20.

The transmission device 10 transmits program data, which indicates content of a broadcast, program, to a reception device via a broadcasting transfer path BT. A video and sound are included in the content. The broadcasting transfer path PT is a transfer path through which the program data is unilaterally and simultaneously transmitted to multiple unspecified reception devices 20. The broadcasting transfer path BT is, for example, a broadcast wave that has a predetermined frequency band. The broadcasting transfer path PT may be configured by including a broadcast satellite IS that relays the broadcast wave. In a part of the broadcasting transfer path ET, a network, for example, a dedicated line or a VPN (Virtual Private Network) may be included. The reception device 20 receives program data that is transferred via the broadcasting transfer path BT.

The reception device 20 displays a video based on the received program data. The reception device 20 is electronic equipment, for example, such as a television reception device or a set-top box, that is able to receive the program data and display a video related to the received program data on a display unit. Though the respective numbers of transmission devices 10 and. reception devices 20 illustrated in FIG. 1 are one, but are typically multi le. A case where the broadcasting system 1 uses an MMT (MPEG Media Transport) system as a media transport system is taken as an example.

The broadcasting system 1 is able to broadcast a plurality of broadcast programs in which luminance ranges of videos are different from each other. In other words, an HDR broadcast program and an SDR broadcast program are broadcasted in the broadcasting system 1. The HDR broadcast program is a broadcast program in which an HDR video whose luminance range is an HDR is included as a component. The SDR broadcast program is a broadcast program in which an SDR video whose luminance range is an SDR is included as a component. Video data representing the HDR video and video data representing the SDR video are respectively called HDR video data and SDR video data.

### Luminance of Video

There are two types of luminance of a video; optical luminance and image luminance. The optical luminance is one of physical amounts indicating brightness of a light source. The optical luminance is used for indicating brightness of a video obtained through light emission from a display, for example. In. the present embodiment, a luminance range of 0 to 10000 cd/m² is referred to as the HDR and a luminance range of 0 to 100 cd/m² is referred to as the SDR, for example. That is, the HDR indicates a wider dynamic range of the optical luminance than that of the SDR. Note that, the luminance ranges of the HDR and the SDR are not limited to the aforementioned ranges, and may be defined as any ranges in accordance with the broadcasting system, for example. Hereinafter, the dynamic range of the optical luminance is simply called a dynamic range in some cases. The image luminance means a signal level indicating brightness of a video or a relative value thereof. In the following description, the optical luminance and the image luminance are respectively called luminance and a luminance value in some cases. Moreover, in the embodiment described below, a case where adjustment of the luminance is performed mainly on the basis of the luminance value is taken as an example, but adjustment of the luminance may be performed by performing conversion between the luminance value and the luminance.

The broadcasting system 1 transfers broadcast program data that includes HDR video data or SDR video data. The HDR video data is constituted by a video format, for example, defined by SMPTE (Society of Motion Picture and Television Engineers) ST. 2084-2014, ARIB (Association of Radio Industries and Businesses; general incorporated association) STD-B67, or the like. In the following description, this video format is called an HDR format. In the HDR video data, the luminance in the luminance range of the HDR is associated with the luminance value. For example, when the luminance value of each pixel is represented by 10 bits, the luminance value of 64 (reference black luminance) to 940 or 1019 (peak white luminance) corresponds to the luminance of 0 to 10000 cd/m². The SDR video data is constituted by a video format defined by Rec. ITU-R BT. 709, for example. In the following description, this video format is called an SDR format. In the SDR video data, the luminance in the luminance range of the SDR is associated with the luminance value. In the SDR video data, a bit number for representing the luminance value of each pixel is less than that of the HDR video data. For example, when the luminance value of each pixel is represented by 8 bits, the luminance value of 16 (reference black luminance) to 235 (reference white luminance) corresponds to the luminance of 0 to 100 cd/m².

### Configuration of Transmission Device

Next, a configuration of the transmission device 10 according to the present embodiment will be described.

FIG. 2 is a schematic block diagram illustrating the configuration of the transmission device 10 according to the present embodiment.

The transmission device 10 multiplexes program data and service information and transmits the multiplexed data obtained through the multiplexing to the broadcasting transfer path BT. The program data includes video data and sound data. The transmission device 10 is configured by including a coding control unit 110, a video coding unit 120, a sound coding unit 130, a service information acquisition unit 140, a multiplexing unit 150, an encryption unit 160, and a transmission unit 170.

The coding control unit 110 controls coding processing for the video data input to the video coding unit 120 and coding processing for the sound data input to the sound coding unit 130. The coding control unit 110 detects luminance value indicated by the video data and a luminance range indicated by the luminance value for each program. For example, when the detected luminance range exceeds a predetermined luminance range of the SDR, the coding control unit 110 selects the HDR format, and, when the detected luminance range does not exceed the predetermined luminance range of the SDR, the coding control unit 110 selects the SDR format. The coding control unit 110 specifies the selected format for the video coding unit 120. Note that, the codling control unit 110 specifies a predetermined format (for example, data format defined by ISO/TEC 14496-3 MPEG-4 AUDIO) for the sound coding unit 130.

The coding control unit 110 outputs, to the service information acquisition unit 140, information of the selected data formats of the video data and the sound data and information of the detected luminance range.

The video coding unit 120 codes the input video data by using a predetermined coding technique (for example, ISO/IEC 23008-2 HEVC: High Efficiency Video Coding). The video coding unit 120 generates video data that includes video coded data obtained through the coding and has the format specified by the coding control unit 110. The video coding unit 120 outputs the generated video data to the multiplexing unit 150.

The sound coding unit 130 codes the input sound data by using a predetermined coding technique (for example, ISO/IEC 14496-3 MPEG-4 AUDIO). The sound coding unit 130 outputs, to the multiplexing unit 150, sound data that includes sound. coded data obtained through the coding and has the format specified by the coding control unit 110.

The service information acquisition unit 140 generates service information on the basis of information about the data format and information about the luminance range that are input from the coding control unit 110. The service information is information about provision of broadcast service, such as a provision form or configuration of a program. The service information is included in, for example, MMT-SI (MPEG Media Transport-Service Information) in an MMT system. The MMT-SI includes, for example, an MPT (MMT Package Table) and an MH-EIT (ME-Event Information Table). The MPT is a data table that includes information indicating an asset that is a component of the program, that is, a list of videos or sounds, or a providing condition thereof.

The MH-EIT is a data table that includes, for each at programs, information about the program, for example, information indicating a name of the program, a broadcast date and time, explanation for broadcast content, or the like. The service information acquisition unit 140 includes, in the MH-EIT, luminance information that is information about a luminance range of a video constituting the program. The luminance information includes video signal transfer characteristics indicating whether or not the luminance range of the video is the HDR. An example of the service information will be described later. The service information acquisition unit 140 outputs the acquired service information to the multiplexing unit 150 every predetermined time (for example, 0.1 to 0.5 ms). The service information is updated in accordance with progress of the program. When the service information is not updated, the same service information is iterated multiple times. Thereby, the reception device 20 is able to present the program on the basis of a broadcast signal received at any time point.

Note that, service information that is generated in advance may be input from another device to the service information acquisition unit 140.

The multiplexing unit 150 multiplexes the video data input from the video coding unit 120, the sound data input from the sound coding unit 130, and the service information input from the service information acquisition unit 140 to generate multiplexed data having a predetermined format (for example, MMT format). The multiplexing unit 150 outputs the multiplexed data that is generated to the encryption unit 160. Note that, any one or both of video data and sound data may be input to the multiplexing unit 150 from another device. When a format of the video data from another device is similar to the format of the video data from the video coding unit 120, the video coding unit 120 may be omitted. When a format of the sound data from another device is similar to the format of the sound data from the sound coding unit 130, the sound coding unit 130 may be omitted.

By using a predetermined encryption technique (for example, AES: Advanced Encryption Standard), the encryption unit 160 encrypts the multiplexed data input from the multiplexing unit 150. The encryption unit 160 outputs encrypted data obtained through the encryption Co the transmission unit 170.

The transmission unit 170 modulates the encrypted data. input from the encryption unit 160 to generate a broadcast signal having a predetermined frequency band. The transmission unit 170 transmits the generated broadcast signal to the broadcasting transfer path BT. The broadcast signal is transferred as a broadcast wave. Thus, the broadcast signal carrying the multiplexed data in which the program data and the service information are multiplexed is transferred through the broadcasting transfer path BT. The transmission unit 170 is configured by including a transmitter, for example. Note that, when data of a program and service information concerning the program are matched, the program data to be transmitted may not be necessarily the program data input to the transmission device 10 at that time point. The time point when the program data is transmitted may be stored in advance in a storage unit provided in the transmission device 10 and specified on the basis of a broadcast time of each program indicated by schedule data input to the transmission device 10.

(Configuration of Reception Device)

Next, a configuration of the reception device 20 according to the present embodiment will be described.

FIG. 3 is a schematic block diagram illustrating the configuration of the reception device 20 according to the present embodiment.

The reception device 20 is configured by including a broadcast reception unit 210, a decoding unit 211, a separation unit 212, an input unit 215, a video decoding unit 221, a video processing unit 222, a luminance adjustment unit 223, a sound decoding unit 231, a control unit 240, a storage unit 250, a display unit 22, and an amplification unit 23. One or both of the display unit 22 and the amplification unit 23 may be detachably attachable to a main body of the reception device 20.

To the broadcast reception unit. 210, a channel tuning signal from a channel tuning unit 241 of the control unit 240 is input. The broadcast reception unit 210 receives a broadcast signal that is transferred on a channel specified by the channel tuning signal. The broadcast reception unit 210 is configured by including a tuner that receives a broadcast wave, for example. The tuner receives a broadcast wave of a frequency band corresponding to the channel specified by the channel tuning signal. The broadcast reception unit 210 demodulates the received broadcast signal and outputs encrypted data obtained through the demodulation to the decoding unit 211.

By using a predetermined decoding technique, the decoding unit 211 decodes the encrypted data input from the broadcast reception unit 210. The predetermined decoding technique is a decoding technique according to an encryption technique used for the generation of the encrypted data. The decoding unit 211 outputs multiplexed data obtained through the decoding to the separation unit 212.

The separation unit 212 separates program data and service information from the multiplexed data input from the decoding unit 211. The separation unit 212 also separates video data and sound data from the program data. The separation unit 212 outputs the separated video data to the video decoding unit 221 and outputs the separated sound data to the sound decoding unit 231. The separation unit 212 outputs the separated service information to a service information processing unit 242.

To the input unit 215, an operation signal generated by an operation of a user is input. The input unit 215 is configured by including an infrared interface that receives an operation signal from a remote controller (control device) RC by an infrared ray, for example. The operation signal specifies, for example, information of on/off of a power supply, a channel on which a broadcast wave is received, luminance or a luminance range, or the like. The input unit 215 outputs the operation signal to the control unit 240. Note that, the input unit 215 is configured by including a physical member for receiving the operation of the user, for example, such as various buttons or knobs, and may generate an operation signal according to the operation. The input unit 215 outputs the input operation signal to the control unit 240.

To the video decoding unit 221, video data having a format specified from the service information processing unit 242 is input from the separation unit 212. The video decoding unit 221 decodes the input video data by using a predetermined video decoding technique. The predetermined video decoding technique is a decoding technique according to the coding technique used for the generation of the video data. The video decoding unit 221 outputs the decoded video data to the video processing unit 222.

The video processing unit 222 performs predetermined processing related to display of a video. The video processing unit 222 is configured by including the luminance adjustment unit 223. When the input video data is HDR video data, the luminance adjustment unit 223 adjusts luminance of a video indicated by the HDR video data on the basis of luminance adjustment information set by a luminance setting unit 244 (described later). The luminance adjustment information includes information that indicates a luminance value related to target luminance for each of adjustment points. The adjustment point is screen display that is set to predetermined subject luminance to be specified by an operation. In the adjustment of the luminance, the luminance adjustment unit 223 converts the luminance of the video so that subject luminance before the adjustment, which is indicated by the adjustment point, is set as target luminance after the adjustment. The video processing unit 222 also converts luminance of a luminance setting screen that is indicated by luminance setting screen data (described later) input from a display information output unit 243, in a similar manner to the case of the video indicated by the HDR video data. The luminance adjustment unit 223 outputs, to the display unit 22, video data indicating the video whose luminance is adjusted. The adjustment of the luminance will be described later.

To the video processing unit 222, display information is input from the display information output unit 243 in some cases. The video processing unit 222 generates video data that indicates a video in which the display information is superimposed with the video indicated by the video data input from the video decoding unit 221 or the video whose luminance is adjusted by the luminance adjustment unit 223. However, in a case where the luminance setting screen data is input as the display information, the video processing unit 222 superimposes the luminance setting screen in which luminance is adjusted by the luminance adjustment unit 223. As the display information, in addition to a setting screen such as the luminance setting screen, there is luminance display information indicating that a luminance range of a video is the HDR. An example of the luminance setting screen will be described later.

The display unit 22 displays the video based on the video data input from the video process unit 222. The display unit 22 is a display capable of displaying luminance in the luminance range of the HDR video as a display capability thereof. The display unit 22 is, for example, liquid crystal display (LCD), an organic EL (Electroluminescence) display, or the like. The organic EL display is a display having an organic light emitting diode (OLED) as a light emitting element.

To the sound decoding unit 231, sound data having a format specified from the service information processing unit 242 is input from the separation unit 212. The sound decoding unit 231 decodes the input sound data by using a predetermined sound decoding technique. The predetermined sound decoding technique is a decoding technique according to the coding technique used for the generation of the sound data. The sound decoding unit 231 outputs the decoded sound data to the amplification unit 23.

The amplification unit 23 reproduces sound based on the sound data input from the sound decoding unit 231. The amplification unit 23 is configured by including a speaker, for example.

The control unit 240 performs various control related to an operation of the reception device 20. The control unit 240 is configured by including the channel tuning unit 241, the service information processing unit 242, the display information output unit 243, and the luminance setting unit 244.

The channel tuning unit 241 identifies a channel, on which a broadcast signal is received, by the operation signal input from the input unit 215. The channel tuning unit 241 generates a channel tuning signal to specify the identified channel and outputs the generated channel tuning signal to the broadcast reception unit 210.

The service information processing unit 242 performs various control related to presentation of a program on the basis of the service information input from the separation unit 212. The service information. processing unit 242 extracts an MH-EIT from the service information. The service information processing unit 242 detects, from the ME-EIT, a video component descriptor of a program that is received at that time point, and determines whether or not the luminance range of the video indicates the HDR in accordance with video signal transfer characteristics included in the detected video component descriptor. When determining that the luminance range indicates the HDR, the service information processing unit 242 outputs the video signal transfer characteristics to the display information output unit 243.

Further, the service information processing unit 242 specifies a format of the video data and a format of the sound data as components of program data on the basis of an MPT included in the service information. The service information processing unit 242 notifies the video decoding unit 221 of the specified format of the video data and notifies the sound decoding unit 231 of the specified format of the sound data.

When the video signal transfer characteristics indicating the HDR as the luminance range are input from the service information processing unit 242, the display information output unit 243 reads luminance setting screen data that is stored in advance in the storage unit 250. The display information output unit 243 outputs the read luminance setting screen data as display information to the video processing unit 222 and the luminance setting unit 244. When the luminance setting screen data is output to the video processing unit 222, the luminance setting screen is displayed on the display unit 22.

The luminance setting screen data is data indicating the luminance setting screen in which target luminance is set. The luminance setting screen includes at least one, that is, one or more adjustment points. Subject luminance of at least one adjustment point is a predetermined maximum value of a luminance value for the HDR video. The adjustment point is set for each subject luminance before adjustment and is constituted as a screen part for setting target luminance upon pressing. The adjustment point is displayed with luminance equal to the target luminance that is set by adjustment of the luminance by the luminance adjustment unit 223. The pressing means that, as an operation signal generated by an operation of the user, an operation signal to specify a display area of an image thereof or coordinates in the display area is input from the input unit 215 in some cases. The luminance setting screen will be described in detail later.

To the luminance setting unit 244, the luminance setting screen data is input from the display information output unit 243. The luminance setting unit 244 decides target luminance which is specified by pressing for the adjustment point in the luminance setting screen displayed. on the display unit 22. The luminance setting unit 244 decides the luminance for displaying the adjustment point as luminance equal to the target luminance that is set. In this case, the luminance setting unit 244 sets an initial value of the target luminance as luminance equal to the subject luminance. The luminance setting unit 244 generates luminance adjustment information indicating a relationship between the subject luminance before adjustment and the target luminance after adjustment, for each adjustment point. The luminance adjustment information may be represented as a conversion equation for converting subject luminance into target luminance or a conversion table indicating a set of subject luminance and target luminance corresponding to the subject luminance. The luminance setting unit 244 outputs the generated luminance adjustment information to the luminance adjustment unit 223.

The storage unit 250 stores various data such as setting data used in the control unit 240 and data acquired by the control unit 240. The storage unit 250 is configured by including various storage media such as a RAM (Random Access Memory) and a ROM (Read-only Memory). The storage unit 250 may be configured by including a storage medium. (for example, BD (Blu-ray (registered trademark) Disc)) in which received video data of a broadcast program or video data of content of a movie or the like produced in advance is stored. In the storage unit 250, broadcast program data and service information which is multiplexed with the broadcast program data may be stored in association with each other.

### MH-EIT

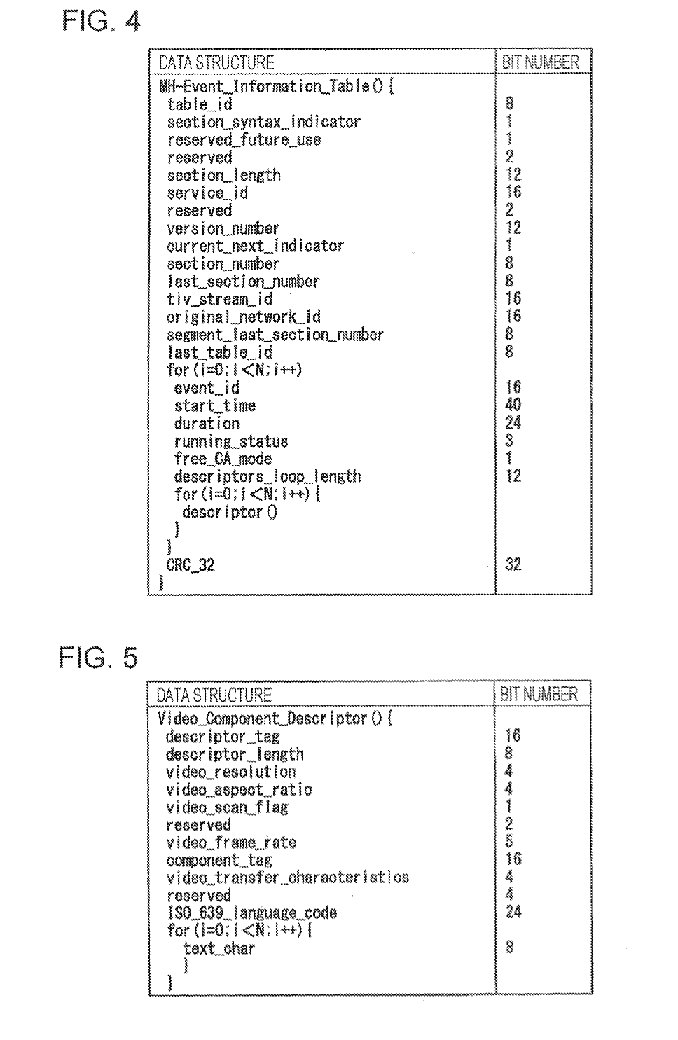

Next, a data structure of an MH-EIT included in service information will be described. FIG. 4 illustrates an example of the data structure of the MH-EIT according to the present embodiment.

In the example lustrated in FIG. 4, the MH-EIT (MH-Event_Information_Table( )) includes, for each of events, an event identification (event_ID), a start time (start_time), a duration time (duration), and a descriptor area (descriptor( )). The event identification indicates an identification number of an event, that is, identification information of a program. The start time indicates a start time of the program. The start time also includes information of a date and time. The duration time indicates a length of a broadcast time of the program.

The MH-EIT also includes a descriptor area (descriptor ( )) of each event identification. The descriptor area is an area in which a descriptor indicating various types of information about the program is stored. For example, a video component descriptor is described in the descriptor area. The service information acquisition unit 140 of the transmission device 10 generates the MH-EIT that includes the video component descriptor in which luminance information about luminance of a video of the program to be broadcasted is described. The service information processing unit 242 of the reception device 20 detects the video component descriptor from the MH-EIT included in the service information and reads video signal transfer characteristics described in the detected video component descriptor.

### Video Component Descriptor

Next, a data structure of a video component descriptor will be described. FIG. 5 illustrates an example of the data structure of the video component descriptor according to the present embodiment.

The video component descriptor (Video_Component_Descriptor( )) is a descriptor in which various parameters and explanation related to the video to be provided in the program are described. The video component descriptor includes video signal transfer characteristics (video_transfer_characteristics) as information for identifying transfer characteristics of a video signal. The video signal transfer characteristics are transfer characteristics of the video, that is, 4-bit information flag indicating a relationship between a luminance value (image luminance) and luminance (optical luminance). To the video signal transfer characteristics, any integer value of 0 to 15 is set in accordance with characteristics of the video to be provided in the program.

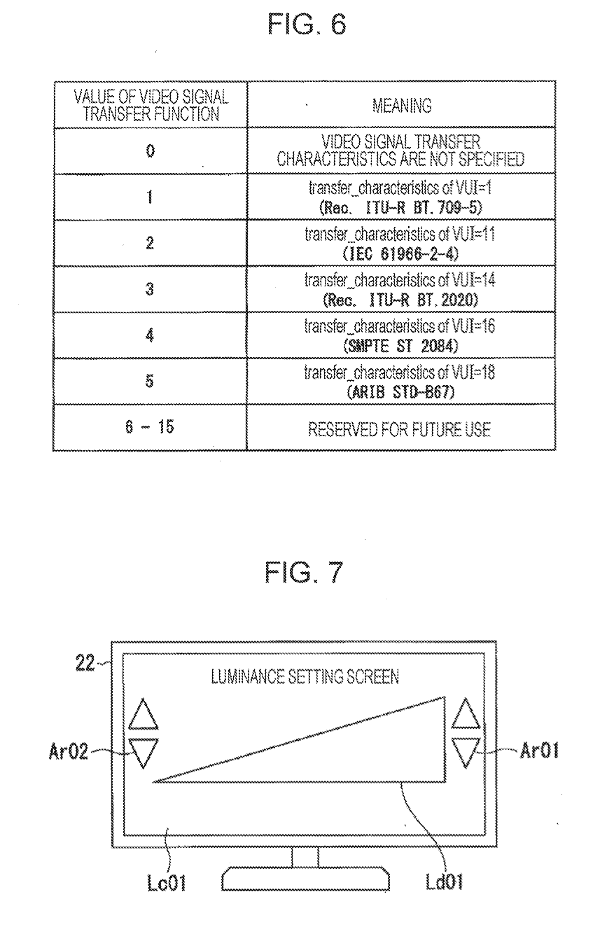

FIG. 6 illustrates a relationship between a value of a video signal transfer function and a meaning thereof. In the relationship, the value of the video signal transfer characteristics being 4 indicates a transfer function. specified when a setting value of a transfer function (transfer_characteristics) of VUI (Video Usability Information) is 16, that is, a transfer function for an HDR video defined by the SMPTE ST 2084. The value of the video signal transfer characteristics being 5 indicates a transfer function specified when the setting value of the transfer function of the VUI is 18, that is, a transfer function for an HDR video defined by the ARIB STD-B67. Accordingly, when the value of the video signal transfer function is 4 or 5, the service information processing unit 242 is able to determine that the luminance range of the video to be broadcasted is the HDR. When the value of the video signal transfer function is another value, for example, any value of 1 to 3, the service information processing unit 242 is able to determine that the luminance range of the video to be broadcasted is the SDR.

Note that, according to the SMPTE ST 2084, the luminance value of HDR data indicating a reference white level (reference white) that is maximum luminance of the SDR is defined as 512 (in the case of 10 bits), and a minimum value of the luminance value of HDR data indicating a reference black level (black) is defined as 64 (in the case of 10 bits). Thus, when the value of the video signal transfer function is 4, the luminance setting unit 244 is able to set the luminance values indicating the reference black level and the reference white level which are predetermined for the HDR data to 64 and 512 (in the case of 10 bits), respectively. According to the ARIB STD-B67, the luminance value of HDR data indicating the reference white level that is maximum luminance of the SDR is defined as 502 (in the case of 10 bits), and a minimum value of the luminance value of HDR data indicating the reference black level is defined as 64 (in the case of 10 bits). Thus, when the value of the video signal transfer function is 5, the display information output unit 243 is able to set the luminance values indicating the reference black level and the reference white level which are predetermined for the HDR data to 64 and 502 (in the case of 10 bits), respectively.

### Luminance Setting Screen

Next, an example of a luminance setting screen will be described. FIG. 7 illustrates a luminance setting screen Lc01 that is an example of the luminance setting screen according to the present embodiment.

The luminance setting screen. Lc01 includes a target luminance chart Ld01 and two sets of arrow button pairs Ar01 and Ar02. The target luminance chart Ld01 is an image that has a left end and a right end as adjustment points and represents a range of luminance adjusted in accordance with target luminance that is set. Subject luminance of the adjustment point at the left end and subject luminance of the adjustment point at toe right end respectively serve as a minimum value and a maximum value of luminance of an HDR video. That is, the luminance at the left end and the luminance at the right end in the target luminance chart Ld01 have a minimum value and a maximum value of the adjusted luminance, and, in an intermediate area between the left end and the right end, the luminance continuously (gradually) becomes high from a left end to a right end. The target luminance chart Ld01 has a right triangle shape that has a bottom side whose direction is a horizontal direction and has a vertical width which increases from a left side to a right side. The vertical width becoming wider toward the right side encourages a user to intuitively recognize that the adjusted luminance indicated closer to the right side is high.

The arrow button pairs Ar01 and Ar02 are button pairs by which the maximum value and the minimum value of the luminance are respectively set as target luminance of the adjustment points at the right end and the left end by pressing. Thus, the subject luminance related to the arrow button pair Ar01 and the subject luminance related to the arrow button pair Ar02 have a maximum value (for example, peak white level) and a minimum value (for example, reference black level) of the luminance value for HDR video data. The subject luminance having the maximum value and the subject luminance having the minimum. value are set as values of the respective corresponding target luminance. That is, in a case where the maximum value and the minimum value of the luminance value of the HDR video data are respectively the peak white level and the reference black level, the luminance at the right end and the luminance at the left end in the target luminance chart Ld01 that is originally displayed are respectively maximum luminance (for example, 10000 cd/m²) and minimum luminance (for example, 0 cd/m²) which are predetermined for the HDR. The arrow button pairs Ar01 and Ar02 are arranged at positions on the right side of the right end and the left side of the left end in the target luminance chart Ld01 in an adjacent manner. Each of the arrow button pairs Ar01 and Ar02 includes one upward arrow button and one downward arrow button and the buttons are formed to be aligned vertically. The upward arrow button is a button for further increasing the target luminance that is set by pressing. The downward arrow button is a button for further reducing the target luminance that is set by pressing.

Then, every time the upward arrow button of the arrow button pair AR01 is pressed once or is continuously pressed for a predetermined time (for example, 0.5 to 1 second), the luminance setting unit 244 increases the luminance value of the target luminance that is set, at that, time point by a predetermined change amount. The predetermined change amount is 1 to 3, for example. Every time the downward arrow button of the arrow button pair Ar01 is pressed once or is continuously pressed for the predetermined time, the luminance setting unit 244 decreases the luminance value of the target luminance that is set at that time point by the predetermined change amount.

Similarly, every time the upward arrow button of the arrow button pair Ar02 is pressed once or is continuously pressed for the predetermined time, the luminance setting unit 244 increases the luminance value of the target luminance that is set at that time point by the predetermined change amount. Every time the downward arrow button of the arrow button pair Ar02 is pressed once or is continuously pressed for the predetermined time, the luminance setting unit 244 decreases the luminance value of the target luminance that is set at that time point by the predetermined change amount.

Every time new target luminance is set, the luminance setting unit 244 generates luminance adjustment information indicating a relationship between luminance before conversion of an HDR video signal and luminance after the conversion on the basis of a minimum value and a maximum value as the target luminance that are respectively set in association with the minimum value and the maximum value as the subject luminance.

The luminance adjustment information is generated in a format according to a conversion method of luminance. In a case where a clipping method is set as the conversion method, the luminance setting unit 244 generates, as the luminance adjustment information, information indicating the minimum value and the maximum value as the target luminance as they are, for example.

When determining that the luminance value of each of pixels indicated by the HDR video data input from the video decoding unit 221 is larger than the maximum value of the target luminance by referring to the luminance adjustment information, the luminance adjustment unit 223 decides the adjusted luminance value as the maximum value of the target luminance. When determining that the luminance value of each of pixels indicated by the HDR video data input from the video decoding unit 221 is smaller than the minimum value of the target luminance, the luminance adjustment unit 223 decides the adjusted luminance value as the minimum value of the target luminance.

The luminance setting unit 244 may generate, as the luminance adjustment information, a conversion table by using the minimum value and the maximum value which are set as the target luminance. The conversion table for the clipping method is formed in such a manner that an input value larger than a maximum value as target luminance is associated with the maximum value as an output value, and an input value between a minimum value and the maximum value as the target luminance is associated with a value equal to the input value as an output value, and an input value smaller than the minimum value as the target luminance is associated with the minimum value as an output value.

By referring to the conversion table, with the luminance value of each of pixels indicated by the HDR video data input from the video decoding unit 221 as an input value, the luminance adjustment unit 223 specifies an output value associated with the input value with reference to the conversion table. The luminance adjustment unit 223 decides the specified output value as the adjusted luminance value.

In a case where a compression method is set as the conversion method, the luminance setting unit 244 calculates, as the luminance adjustment information, for example, conversion parameter for linearly converting a luminance value between the minimum value and the maximum value of the luminance value, which are subject luminance and are predetermined for the HDR video, into a luminance value between the minimum value and the maximum value which are set as the target luminance. The conversion parameter includes, for example, a compression ratio indicating a ratio of a change of the luminance value after the conversion relative to a change of the luminance value before the conversion, and an offset value indicating the luminance value after the conversion that is provided when the luminance value before the conversion is 0.

On the basis of the conversion parameter, the luminance adjustment unit 223 calculates the luminance value between the minimum value and the maximum value of the target luminance from the luminance values of each of pixels indicated by the HDR video data input from the video decoding unit 221, and decides the calculated luminance value as the adjusted luminance value.

The luminance setting unit 244 may generate, as the luminance adjustment information, a conversion table for a compression method by using the minimum value and the maximum value which are set as the target luminance. The conversion table for the compression method is formed in such a manner that each luminance value between the minimum value and the maximum value of the luminance value, which are subject luminance and are predetermined for the HDR video, and a luminance value obtained by linearly converting the luminance value by using the conversion parameter are associated with each other as an input value and an output value, respectively.

By referring to the conversion table, with the luminance value of each of pixels indicated by the HDR video data input from the video decoding unit 221 as an input value, the luminance adjustment unit 223 specifies an output value associated with the input value with reference to the conversion table. The luminance adjustment unit 223 decides the specified output value as the adjusted luminance value.

The luminance adjustment unit 223 performs the aforementioned processing of adjustment of the luminance also for luminance setting screen data, in addition to the HDR video data input from the video decoding unit 221. Thus, the respective luminance at the right end and the left end that are the adjustment points of the target luminance chart Ld01 serves as maximum luminance and minimum luminance which are set as target luminance.

Accordingly, when the user performs an operation of pressing the arrow button pair Ar01 or Ar02 while seeing a part of the maximum luminance or the minimum luminance displayed at the right end or the left end of the target luminance chart Ld01, the maximum luminance or the minimum luminance is adjusted. This makes it possible for the user to easily adjust the maximum luminance or the minimum luminance of the HDR video through the operation.

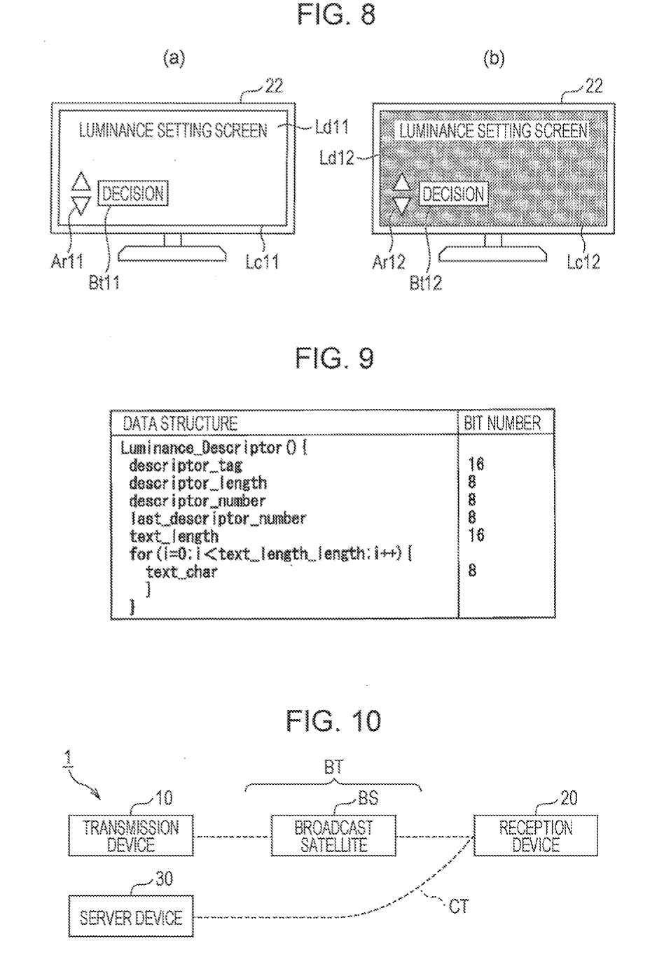

Next, another example of the luminance setting screen will be described. FIG. 8 illustrates luminance setting screens Lc11 and Lc12 as another example of the luminance setting screen according to the present embodiment.

Each of the luminance setting screens Lc11 and Lc12 is as example of a screen on which respective target luminance corresponding to a minimum value and a maximum value of a luminance value for an HDR video is individually set as subject luminance. The luminance setting screens Lc11 and Lc12 are sequentially displayed.

FIG. 8(a) illustrates the luminance setting screen Lc11 as another example of the luminance setting screen. The luminance setting screen Lc11 is displayed immediately after a luminance range of a video to be broadcasted is determined as the HDR. Here, when video signal transfer characteristics indicating the HDR as the luminance range are input from the service information processing unit 242, the display information output unit 243 outputs, to the video processing unit 222, luminance setting screen data which is read from the storage unit 250 and indicates the luminance setting screen Lc11.

The luminance setting screen Lc11 is configured by including a target luminance chart Ld11, an arrow button pair Ar11, and a decision button Bt11.

The target luminance chart Ld11 is an image in which luminance to be displayed is target luminance that is set by using the arrow button pair Ar11. The subject luminance related to the arrow button pair Ar11 is a predetermined maximum value (for example, peak white level) of the luminance value for the HDR video data and is a luminance value that is set as an initial value of the target luminance. That is, the arrow button pair Ar11 is a button pair by which the maximum value of the luminance is set as the target luminance by pressing. The target luminance chart Ld11 is an adjustment point by which a maximum value of the luminance after conversion is provided before conversion. In the example illustrated in FIG. 8 (a), the target luminance chart Ld11 occupies an almost entirety of the luminance setting screen Lc11 excluding areas of the arrow button pair Ar11 and the decision button Bt11. Thus, depending on a change of the target luminance that is set, the luminance of the almost entirety of the luminance setting screen Lc11 changes.

The arrow button pair Ar11 includes one upward arrow button and one downward arrow button. The luminance setting unit 244 sets the target luminance corresponding to the predetermined maximum value of the luminance for the HDR video in accordance with pressing of the arrow button pair Ar11, in a similar manner to the case of the arrow button pair Ar01. In the example illustrated in FIG. 8 (a), the arrow button pair Ar11 is displayed at a position in a predetermined range from a lower left end of the luminance setting screen Lc11.

The decision button Bt11 is a button by which setting of the target luminance corresponding to the predetermined maximum value of the luminance value for the HDR video is finished by pressing. Then, when the decision button Bt11 is pressed, the display information output unit 243 stops output of luminance setting screen data indicating the luminance setting screen Lc11. Thereby, the luminance setting screen Lc11 is deleted. Then, the display information output unit 243 reads, from the storage unit 250, luminance setting screen data that is stored in advance and indicates the luminance setting screen Lc12. The display information output unit 243 outputs the read luminance setting screen data to the video processing unit 222. Thereby, the luminance setting screen Lc12 is newly displayed on the display unit 22.

FIG. 8(b) illustrates the luminance setting screen Lc12 as another example of the luminance setting screen. The luminance setting screen Lc12 is configured by including a target luminance chart Ld12, an arrow button par Ar12, and a decision button Et12.

The target luminance chart Ld12 is an image in which luminance to be displayed is target luminance that is set by using the arrow button pair Ar12. Subject luminance related to the arrow button Ar12 is a predetermined minimum value (for example, reference black level) of the luminance value for the HDR video data and is a luminance value that is set as an initial value of the target luminance.

The arrow button pair Ar12 is a button pair by which the minimum value of the luminance is set as the target luminance by pressing The arrow button pair Ar12 includes one upward arrow button and one downward arrow button. The luminance setting unit 244 sets the target luminance in which the predetermined minimum value of the luminance value for the HDR video is the subject luminance in accordance with pressing of the arrow button pair Ar12, in a similar manner to the case of the arrow button pair Ar02.

The decision button Bt12 is a button by which setting of the target luminance corresponding to the predetermined minimum value of the luminance value for the HDR video is finished by pressing. Then, when the decision button Bt12 is pressed, the display information output unit 243 stops output of luminance setting screen data indicating the luminance setting screen Lc12. Thereby, display of the luminance setting screen Lc12 is stopped.

Then, the luminance setting unit 244 generates luminance adjustment information indicating the respective target luminance set for the minimum value and the maximum value of the luminance value, which are predetermined for the HDR video, and outputs the generated luminance adjustment information to the luminance adjustment unit 223.

Note that, the luminance setting screen Lc01 illustrated in FIG. 7 may also include a decision button (not illustrated). When the decision button is pressed, the display information output unit 243 may stop output of luminance setting screen data indicating the luminance setting screen Lc01.

Moreover, after display of the luminance setting screen Lc01, Lc11, or Lc12 starts or when a time period during which the arrow button pair Ar01, Ar11, or Ar12 is not pressed has lapsed for a predetermined time (for example, 30 seconds) or more, the display information output unit 243 may stop output of luminance setting screen data thereof.

Though each of the luminance setting screen Lc01 illustrated in FIG. 7 and the luminance setting screens Lc11 and Lc12 illustrated in FIG. 8 occupies an entirety of a display area of the display unit 22, there is no limitation thereto. Each of the luminance setting screens Lc01, Lc11, and Lc12 may be a part of the display area of the display unit 22 as long as having a size that allows a user to perform an operation while viewing. A length of one side of each of the luminance setting screens Lc01, Lc11, and Lc12 may be, for example, about one eighth or one third of a length of one side of the display area of the display unit 22.

Note that, the luminance setting unit 244 may store, in the storage unit 250, luminance adjustment information generated on the basis of the target luminance that is set for each adjustment point. In a case where there is luminance adjustment information stored in the storage unit 250, the display information output unit 243 may stop output of luminance setting screen data to the video processing unit 222. In this case, on the basis of the luminance adjustment information read from the storage unit 250, the luminance adjustment unit 223 adjusts the luminance of the video indicated by the HDR video data input from the video decoding unit 221.

Thereby, the luminance adjustment information based on the set target luminance is used for adjustment of the luminance of the HDR video, so that the target luminance does not need to be set again. Further, since a luminance setting screen is not displayed, visibility of the video is not prevented.

Moreover, till when an operation signal for luminance setting is input, the luminance setting unit 244 may cause the luminance adjustment unit 223 to limit the luminance of the HDR video to luminance in a predetermined luminance range of the SDR video. The input of the operation signal for luminance setting is an instruction for the luminance setting, for example, pressing of a decision button or pressing of an arrow button pair. When causing the luminance adjustment unit 223 to adjust the luminance of the HDR video to the luminance in the predetermined luminance range of the SDR video, the luminance setting unit 244 generates, for example, luminance adjustment information indicating the reference black level and the reference white level as the respective target luminance of the minimum value and the maximum value of the luminance value, which are predetermined for the HDR video, and outputs the generated luminance adjustment information to the luminance adjustment unit 223. On the basis of the luminance adjustment information from the luminance setting unit 244, the luminance adjustment unit 223 converts the luminance value indicated by the HDR video data input from the video decoding unit 221.

Here, as described above, the luminance setting unit 244 is able to specify the luminance value that provides the reference white level on the basis of a setting value of video signal transfer characteristics. The reference white level corresponds to a luminance value of the HDR video data that provides predetermined maximum luminance to the SDR video. Note that, the reference black level is a luminance value that provides common minimum luminance to the SDR video as predetermined minimum luminance and to the HDR video as the predetermined minimum luminance.

However, the luminance setting screen unit 244 does not adjust the luminance of a luminance setting screen to the luminance in the predetermined luminance range of the SDR video. That is, the respective luminance of adjustment points displayed in the luminance setting screen remains the maximum luminance and the minimum luminance of the HDR video.

### Luminance Display Information

When video signal transfer characteristics indicating that the luminance range of the video is the HDR are input, the display information output unit 243 may output, to the video processing unit 222, luminance display information indicating that the luminance range is the HDR, as display information. Thereby, the luminance display information is displayed in a superimposing manner on the display unit 22. Accordingly, the user is able to immediately recognize that the luminance range of the video that is displayed is the HDR. The luminance display information may be, for example, OSD (On Screen Display) data indicating characters of “HDR” or image data indicating an image of an icon including characters of “HDR”. When acquiring the luminance display information, the display information output unit 243 reads, for example, luminance display information stored in the storage unit 250 in advance. The luminance display information is displayed, for example, in a predetermined range from an upper right end of the display area of the display unit 22.

Note that, the display of the luminance display information may be continued even when the luminance range that is set as the luminance range of the HDR video is equal to or less than the predetermined luminance range for the SDR. The user is able to recognize that the luminance range of the video that is broadcasted is the HDR regardless of the luminance range of the video that is displayed. Thus, a motive for expanding the luminance range of the video by an operation is kept. When determining whether or not the luminance range is equal to or less than the predetermined luminance range for the SDR video, the display information output unit 243 may determine whether the maximum value that is set as the target luminance is equal to or less than the luminance value that provides the reference white level specified by a setting value of video signal transfer characteristics. As described above, the reference white level corresponds to the luminance value of the HDR video data that provides the predetermined maximum luminance to the SDR video as described above.

When video signal transfer characteristics indicating that the luminance range of the video is the predetermined luminance range for the HDR are not input as a program is changed, the display information output unit 243 stops output of the luminance display information. Thereby, the display of the luminance display information is deleted. The change of the program may occur when the program is switched as time has lapsed or when a channel on which a broadcast sig al is received is changed.

When a predetermined time (for example, 15 to 30 seconds) has lapsed after the video signal transfer characteristics indicating that the luminance range of the video is the predetermined luminance range for the HDR are input, the display information output unit 243 may stop output of the luminance display information.

### Modified Example

Next, a modified example of the present embodiment be described. Though a case where subject luminance subjected to luminance adjustment is a maximum value and a minimum value of the luminance value, which are predetermined for an HDR video, has been taken as an example in the embodiment described above, a maximum value and a minimum value of the luminance value of a video provided in a program are used as subject luminance in the present modified example.

The service information acquisition unit 140 of the transmission device 10 according to the present modified example acquires, as luminance information for each of programs, service information that includes luminance information indicating a maximum value and a minimum value of the luminance value of a video provided in the program.

More specifically, the service information acquisition unit 140 detects the maximum value and the minimum value of the luminance value of input video data of the program and generates a luminance descriptor in which the detected maximum value and minimum value are described. The service information acquisition unit 140 generates an MH-EIT by including the generated luminance descriptor in a descriptor area related to the program.

FIG. 9 illustrates an example of a luminance descriptor (Luminance_Descriptor) according to the present embodiment.

The luminance descriptor is configured by including a descriptor tag (descriptor_tag) and luminance description. (text_char). In the descriptor tag, for example, “0x803A” is described as a tag (identifier) indicating that the descriptor is a luminance descriptor. The luminance description is a field in unit of 1 byte, in which sequential luminance information is described. In the luminance description, a maximum value and a minimum value of a luminance value are described. Note that, video signal transfer characteristics may be described in the luminance description. In such a case, the video signal transfer characteristics may not be described in a video component descriptor.

The service information processing unit 242 of the reception device 20 detects, from the MH-EIT included in the service information, a luminance descriptor of a video related to the program that is broadcasted, and reads a maximum value and a minimum value of the luminance value as luminance information described in the detected luminance descriptor. The service information processing unit 242 outputs information of the read maximum value and minimum value of the luminance value to the luminance setting unit 244.

The luminance setting unit 244 decides, as subject luminance of adjustment points related to a minimum value and a maximum value of a luminance value for HDR video data, the minimum value and the maximum value of the luminance value, which are input from the service information processing unit 242. Thus, the minimum value and the maximum value of the luminance value, which are set as initial values of target luminance, are respectively the minimum value and the maximum value of the luminance value of the HDR video data provided in the program that is broadcasted. Therefore, luminance of adjustment points included in a luminance setting screen displayed on the display unit 22 serves as minimum luminance and maximum luminance of the video. This makes it possible for the user to intuitively recognize the luminance range of the video provided in the grogram. As a result, the user is able to determine whether or not the luminance range needs to be adjusted on the basis of the recognized luminance range and easily adjust the luminance range to a desired luminance range.

As described above, the reception device 20 according to the present embodiment includes the display information output unit 243 that, when a video of a program is determined as an HDR video, which has a luminance range wider than a standard luminance range, on the basis of service information of the program, outputs a luminance setting screen that has an adjustment point related to predetermined subject luminance to be specified. The reception device 20 includes the luminance setting unit 244 that sets target luminance of the adjustment point on the basis of as operation, and the luminance adjustment unit 223 that adjusts luminance of the adjustment point displayed on the luminance setting screen and luminance of the video on the basis of luminance adjustment information indicating the target luminance.

With such a configuration, the luminance of the HDR video is adjusted so that the luminance of the adjustment point that is displayed is the target luminance that is set on the basis of the operation and the luminance of the adjustment point is the target luminance that is set from the subject luminance to be specified. Thus, the user is able to set the target luminance of the adjustment point the operation while viewing the adjustment point whose luminance is the target luminance. As a result, the user is able to easily adjust the luminance of the HDR video to desired luminance.

In the reception device 20, the luminance setting screen has at least one adjustment point in which the subject luminance is maximum luminance of the HDR video. The luminance adjustment unit 223 adjusts the luminance of the HDR video from luminance in a luminance range provided by the subject luminance to luminance in a luminance range provided by the target luminance.

With such a configuration, the target luminance of the adjustment point related to the maximum luminance of the HDR video is provided by the operation as toe subject luminance and the luminance in the luminance range provided by the maximum luminance is converted into the luminance in the luminance range provided by the target luminance. Thus, the user is able to set the target luminance of the adjustment point by the operation while viewing the adjustment point whose maximum luminance is the target luminance. As a result, the user s able to easily adjust the luminance of the received HDR video to luminance in a luminance range provided by desired target luminance.

The luminance setting unit 244 sets the subject luminance on the basis of luminance information of the video indicated by the service information of the program.

With such a configuration, the subject luminance related to the adjustment point is decided as an initial value of the target luminance on the basis of the luminance information of the HDR video provided in the program. The target luminance of the adjustment point is able to be set by the operation while viewing the adjustment point whose luminance is adjusted in accordance with luminance distribution of the HDR video provided in the program. As a result, the user is able to easily adjust the luminance of the received HDR video to luminance in a luminance range provided by desired target luminance.

The luminance setting unit 244 causes the storage unit 250 to store the luminance adjustment information, and the luminance adjustment unit 223 adjusts the luminance of the HDR video on the basis of the luminance adjustment information stored in the storage unit 250.

With such a configuration, even when the target luminance is not set displaying the luminance adjustment screen again, the luminance of the HDR video is adjusted by using the luminance adjustment information that is set on the basis of the target luminance.

When the video of the program is determined as the HDR video, the display information output unit 243 outputs luminance range information indicating that the luminance range of the video of the program is HDR.

With such a configuration, display indicating that the luminance range of the program is the HDR is performed. Thus, even when the luminance range of the video to be displayed becomes narrow due to adjustment, the user is able to recognize that the video that is displayed is the HDR video.

### Second Embodiment

Next, a second embodiment of the invention will be described. A configuration that is the same as that of the first embodiment is given the same reference sign and description thereof is incorporated by reference.

FIG. 10 is a schematic block diagram illustrating a configuration of the broadcasting system 1 according to the present embodiment. In the example illustrated in FIG. 1, the broadcasting system 1 is constituted as a broadcast-communication cooperation system by including the transmission device 10, the reception device 20, and further a server device 30. The server device 30 is a communication device that is managed by a broadcasting organization or a program provider, for example.

A communication transfer path CT is a transfer path on which various data is bidirectionally transferred between the server device 30 and the reception device 20. The communication transfer path CT includes, for example, a wide area network such as the Internet or a public wireless communication network. The communication transfer, path CT may partially include a local area network (LAN) or a dedicated access network. Note that, transferring (or transmitting or receiving) various data through the communication transfer path CT is called “transferring (or transmitting or receiving) through communication” in some cases.

When receiving an application request signal from the reception device 20, the server device 30 transmits an application program (hereinafter, called application) to the reception device 20 as a response thereto. The application request signal is a signal for instructing request of a subject application. The application is described in a predetermined description language (for example, HTML5) and has a command to realize various functions for presentation of a program described therein. An example of a function of the application will be described later.

The service information acquisition unit 140 (FIG. 2) of the transmission device 10 according to the present embodiment further acquires application control information, describes, in an MPT, information indicating a location of the acquired application control information, and generates service information that includes the MPT and the application control information. The information indicating the location of the application control information is described in an application service descriptor and stored in an MPT descriptor area of the MPT. The application control information includes URL (Uniform Resource Locator) of the service device 30 as acquisition destination information of the application, and information for controlling execution of start, stop, or the like of the application. The location of the server device 30 may be indicated by an IP address instead of the URL. The control information is represented as, for example, an application information table (MH-AIT) having a predetermined data format.

In the present embodiment, the application may include a luminance setting screen display command and a luminance setting command. The luminance setting screen display command is a command for causing the display information output unit 243 of the reception device 20 (FIG. 3) to display a luminance setting screen on the display unit 22. The luminance setting command is a command for causing the luminance setting unit 244 to set target luminance of each adjustment point to generate luminance adjustment information on the basis of the target luminance that is set. The application may include luminance setting screen data that indicates the luminance setting screen and layout data that indicates a layout of the luminance setting screen and a broadcast video. In addition, the application may include luminance information of a video that is provided in a program. In this case, description of the luminance information may be omitted in the MH-EIT or the MPT.

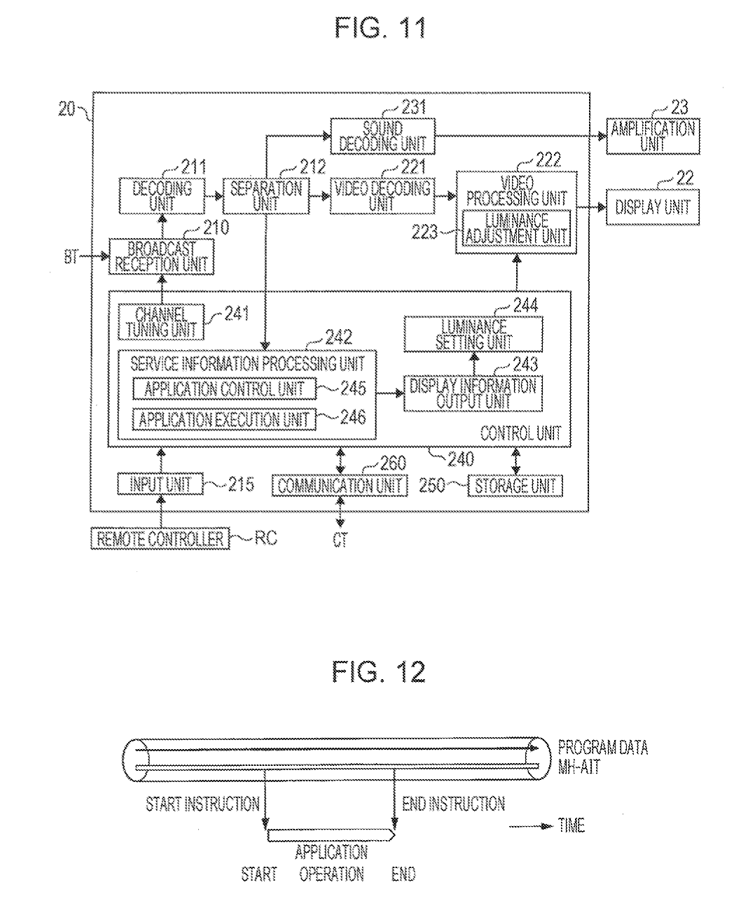

The multiplexing unit 150 further multiplexes the application control information to generate multiplexed data. The service information processing unit 242 (FIG. 11) of the reception device 20 separates an MH-AIT as the application control information from service information input from the separation unit 212. In a case where description of the luminance information is omitted in the MH-EIT or the MPT, the service information processing unit 242 extracts the luminance information from the application received from tine server device 30.

### Reception Device

Next, a configuration of the reception device 20 according to the present embodiment will be described. FIG. 11 is a schematic block diagram illustrating the configuration of the reception device 20 according to the present embodiment.

The reception device 20 according to the present embodiment is configured by further including a communication unit 260.

The communication unit 260 outputs, to the control unit 240, various reception data received from the server device 30 connected through the communication transfer path CT, and transmits, to the service device 30, various transmission data input from the control unit 240. The communication unit 260 is a communication interface, for example.

The service information processing unit 242 is configured by further including an application control unit 245 and an application execution unit 246.

The application control unit 245 acquires the application on the basis of the application control information input from the separation unit 212 and controls processing specified by a command described in the acquired application. Note that, causing the processing specified by the command described in the application to be performed is called “executing the application” or “execution of the application”.

The application control unit 245 extracts acquisition destination information of the application from the application control information and transmits an application request signal to the server device 30 specified by the extracted acquisition destination information. The application control unit 245 receives the application from the service device 30 as a response thereto and outputs the received application to the application execution unit 246. The application control unit 245 controls the application execution unit 246 to execute the application on the basis of various commands included in the application control information.

The application execution unit 246 executes the application input from the application control unit 245. On the basis of a command described in the application, the application execution unit 246 causes another functional unit to execute the aforementioned processing related to presentation of a video. For example, the application execution unit 246 causes the display information. output unit 243 to acquire luminance setting screen data on the basis of a luminance setting screen display command and output the acquired luminance setting screen data to the video processing unit 222. In a case where the luminance setting screen data is included in the application, the display information output unit 243 extracts the luminance setting screen data from the application. In a case where the luminance setting screen data is not included in the application, the display information output unit 243 reads the luminance setting screen data that is stored in advance from the storage unit 250. On the basis of the luminance setting command, the application execution unit 246 causes the luminance setting unit 244 to set target luminance related to an adjustment point displayed on the luminance setting screen in accordance with an instruction of an operation signal. The application execution unit 246 causes the luminance setting unit 244 to generate luminance adjustment information on the basis of the target luminance that is set and output the luminance adjustment information that is generated to the luminance adjustment unit 223. On the basis of the luminance adjustment information input from the luminance setting unit 244, the luminance adjustment unit 223 adjusts luminance of videos indicated by the HDR video data from the video decoding unit 221 and the luminance setting screen data from the display information output unit 243.

### Application Control

Next, an example of application control according to the present embodiment will be described. The application control information includes control information of a start instruction (AUTOSTART), standby (PRESENT), end (KILL), or the like. FIG. 12 illustrates an example of application control according to the present embodiment. The example illustrated in FIG. 12 indicates that the application control unit 245 starts execution of an operation indicated by a command described in the acquired application in response to a start instruction and ends the execution in. response to an end instruction. Timing when the application control unit 245 instructs the start is, for example, after the service information processing unit 242 detects video signal transfer characteristics indicating that a luminance range of a video provided in a program to be broadcasted is the HDR from service information carried by a broadcast signal. The timing when the application control unit 245 instructs the start may be also when an operation signal to instruct luminance setting is input from the input unit 215. Timing when the application control unit 245 instructs end may be, for example, any of when a predetermined time (for example, 15 seconds to 1 minute) has lapsed after the application starts, when a predetermined time has lapsed after target luminance is set last time, and when reception of the corresponding program ends.

### Execution Example

Next, an execution example of the application will be described.

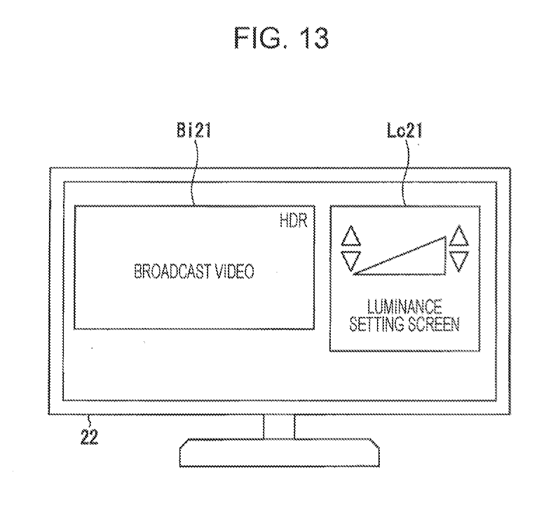

FIG. 13 illustrates the execution example of the application according to the present embodiment.

The execution example illustrated in FIG. 13 indicates an example of display of a screen that is displayed after the application starts. In the example, a broadcast video Bi21 and a luminance setting screen Lc21 are arranged side by side in a display area of the display unit 22. The arrangement is arrangement indicated by layout data included in the application. The application execution unit 246 outputs the layout data to the video processing unit 222 and causes the video processing unit 222 to generate image data that indicates a display image in which the broadcast video Bi21 and the luminance setting screen Lc21 are arranged in an area specified by the layout data.

The broadcast video Bi21 is a video obtained when the application execution unit 246 causes the luminance adjustment unit 223 to adjust luminance of an HDR video indicated by HDR video data input from the video decoding unit 221. As an example of luminance display information, characters of “HDR.” are displayed at an upper right end of the broadcast video Bi21. The application execution unit 246 causes the video processing unit 222 to superimpose the luminance display information with the HDR video whose luminance is adjusted.

The luminance setting screen Lc21 is a video obtained when the application execution unit 246 causes the luminance adjustment unit 223 to adjust luminance of a luminance setting screen indicated by luminance setting screen data extracted from the application by the display information output unit 243. A configuration of the luminance setting screen Lc21 is similar to that of the luminance setting screen Lc01 (FIG. 8). As described above, the application execution unit 246 causes the luminance setting unit 244 to set target luminance of an adjustment point in the luminance setting screen Lc01 upon pressing and generate luminance adjustment information on the basis of the target luminance that is set. Then, the application execution unit 246 causes the luminance adjustment unit 223 to adjust the luminance of the broadcast video Bi21 and the luminance of the luminance setting screen Lc21 on the basis of the luminance adjustment information that is set.

As described above, the reception device 20 according to the present embodiment includes the application control unit 245 that controls execution of processing specified by a predetermined application program on the basis of control information about control of service of the program. The application program causes a computer of the reception device 20 to output the luminance setting screen and set the target luminance.

With such a configuration, execution of the processing specified by the predetermined application program is controlled on the basis of control information about control of the program. As the processing whose execution is controlled, the luminance setting screen is displayed and the target luminance is set in accordance with an operation for the adjustment point that the luminance setting screen has. Thus, a broadcasting organization or a program provider who provides the application program is able to provide setting of luminance of an HDR video as additional service in broadcast.

As above, the embodiments of the invention have been. described in detail with reference to the drawings, but a specific configuration is not limited to the aforementioned embodiments and includes, for example, a design that falls within the gist of the invention. Configurations described in the aforementioned embodiments are able to be combined arbitrarily.

Though a case where luminance information is described in an MH-EIT and carried by a broadcast signal is taken as an example in the aforementioned embodiments, there is no limitation thereto. The service information acquisition unit 140 of the transmission device 10 may generate service information by describing the luminance information in an MPT instead of the MH-EIT. The luminance information is described in an MPT descriptor area or an asset descriptor area for a video that constitutes a program in the MPT, for example. The service information processing unit 242 of the reception device 20 reads the luminance information from the MPT descriptor area or the asset descriptor area in the MPT included in the service information. By describing the luminance information in the asset descriptor area, when there are multiple videos that constitute the program, the luminance adjustment unit 223 is able to immediately specify a video subjected to processing of adjustment of luminance with use of luminance information that is described.

Note that, though an example in which the broadcasting system 1 uses an MMT method as a media transport method has been described in the aforementioned embodiments, there is no limitation thereto. The broadcasting system 1 may use, for example, an MPEG-2 TS method, an RTP (Real-time Transport Protocol) method, or the like.

Note that, though a case where the number of adjustment points included in a luminance setting screen is two and the respective adjustment points indicate a maximum value and a minimum value of luminance and are used for setting of the maximum value and the minimum value has been taken as an example above, there is no limitation thereto. In the luminance setting screen, the number of adjustment points that indicate a maximum value of luminance and are used for setting of the maximum value may be one or three or more. In a case where the number of adjustment points is one, the luminance setting unit 244 may set minimum values of subject luminance and target luminance to a predetermined minimum value (for example, reference black level) of a luminance value for the HDR.

Not that, the invention described above may be carried out also by the following aspect.

(1) A reception device includes: a display information output unit that, when a video of a program is determined as a high dynamic range video, which has a luminance range wider than a standard luminance range, on a basis of service information of the program, outputs a luminance setting screen which has an adjustment point related to predetermined subject luminance to be specified; a luminance setting unit, that sets target luminance of the adjustment point on a basis of an operation; and a luminance adjustment unit that adjusts luminance of the adjustment point and luminance of the video on a basis of luminance adjustment information indicating the target luminance.

(2) In the reception device according to (1), the luminance setting screen has at least one adjustment point in which the subject luminance is maximum luminance of the video, and the luminance adjustment unit adjusts the luminance of the video from luminance in a luminance range provided by the subject luminance to luminance in a luminance range provided by the target luminance.

(3) In the reception device according to (1) or (2), the luminance setting unit sets the subject luminance on a basis of luminance information of the video indicated by the service information.

(4) In the reception device according to any of (1) to (3), the luminance setting unit causes a storage unit to store the luminance adjustment information, and the luminance adjustment unit adjusts the luminance of the video on a basis of the luminance adjustment information stored in the storage unit.

(5) In the reception device according to any of (1) to (4), when the video of the program is determined as the high dynamic range video, the display information output unit outputs luminance range information indicating that the luminance range of the video of the program is that of a high dynamic range video.

(6) The reception device according to any of (1) to (5) further includes an application control unit that controls execution of processing specified by a predetermined application program on a basis of control information about control of service of the program, in which the application program causes a computer of the reception device to output the luminance setting screen and to set the target luminance.

(7) A broadcasting system includes a transmission device and a reception device. The transmission device transmits a program including a video and service information of the program. The reception device includes: a display information output unit that, when a video of the program is determined as a high dynamic range video, which has a luminance range wider than a standard luminance range, on a basis of the service information, outputs a luminance setting screen which has an adjustment point related to predetermined subject luminance to be specified; a luminance setting unit that sets target luminance of the adjustment point on a basis of an operation; and a luminance adjustment unit that adjusts luminance of the adjustment point and luminance of the video on a basis of luminance adjustment information indicating the target luminance.

(8) The broadcasting system according to (7) further includes a communication device that transmits a predetermined application program through communication in response to a request from the reception device, in which the reception device includes an application control unit that controls execution of processing specified by the predetermined application program on a basis of control information about control of service of the program, and the application program causes a computer of the reception device to output the luminance setting screen and to set the target luminance.

The transmission device 10, the reception device 20, and the service device 30 which are described above may be realized by recording a program for realizing functions of the transmission device 10, the reception device 20, and the service device 30 in a computer-readable recording medium and causing a computer system to read the program recorded in the recording medium for execution. Though the program is a program different from the application program described in the second embodiment, a part of functions thereof may be realized on the basis of the application program. Here, “causing a computer system to read the program recorded in the recording medium for execution” includes installing the program in the computer system. The “computer system” here is defined to include an OS and hardware components such as a peripheral device. Further, the “computer system.” may include a plurality of computer devices connected via a network including a communication line such as the Internet, WAN, LAN, or a dedicated line.

The “computer-readable recording medium” refers to a portable medium such as a flexible disk, a magneto-optical disk, a ROM, or a CD-ROM, and a storage device such as a hard disk built into the computer system. Thus, the recording medium storing the program may be a non-transitory recording medium such as a CD-ROM. The recording medium also includes an internal or external recording medium capable of being accessed from a distribution server that distributes the program. A code of the program stored in the recording medium. of the distribution server may be different from a code of a program in a format executable by a terminal device. That is, any format can be used to store the program in the distribution server as long as the program is able to be downloaded from the distribution server and installed in the terminal device in an executable format.

Note that, the program may be configured to be divided into plural pieces and integrated in a terminal device after being downloaded at different timings from each other, and the divided programs may be distributed from different distribution servers from each other. Furthermore, the “computer-readable recording medium” includes a medium that retains the program for a certain time period, such as a volatile memory (RAM) within a server or the computer system serving as a client in a case where the program is transmitted through a network. In addition, the aforementioned program may be configured to realize a part of the functions described above. The aforementioned program may also be a program capable of realizing the functions described above in combination with a program already recorded in the computer system, that is, a so-called difference file (difference program).

### INDUSTRIAL APPLICABILITY

Application to a reception device and a broadcasting system that allow a user to appropriately adjust luminance of an HDR video is able to be performed.

### REFERENCE SIGNS LIST

1 broadcasting system, 10 transmission. device, 20 reception device, 22 display unit, 23 amplification unit, server device, 110 coding control unit, 120 video coding unit, 130 sound coding unit, 140 service information. acquisition unit, 150 multiplexing unit, 160 encryption unit, 170 transmission unit, 210 broadcast reception unit, 211 decoding unit, 212 separation unit, 215 input unit, 221 video decoding unit, 222 video processing unit, 223 luminance adjustment unit, 231 sound decoding unit, 240 control unit, 241 channel tuning unit, 242 service information processing unit, 243 display information acquisition unit, 244 luminance setting unit, 245 application control unit, 246 application execution unit, 250 storage unit, 260 communication unit, BT broadcasting transfer path, ES broadcast satellite, CT communication transfer path, RC control device

1. A reception device comprising:
a display information output unit that, when a video of a program is determined as a high dynamic range video, which has a luminance range wider than a standard luminance range, on a basis of service information of the program, outputs a luminance setting screen which has an adjustment point related to predetermined subject luminance to be specified;
a luminance setting unit that sets target luminance of the adjustment point on a basis of an operation; and
a luminance adjustment unit that adjusts luminance of the adjustment point and luminance of the video on a basis of luminance adjustment information indicating the target luminance.

2. The reception device according to claim 1, wherein
the luminance setting screen has at least one adjustment point in which the subject luminance is maximum luminance of the video, and
the luminance adjustment unit adjusts the luminance of the video from luminance in a luminance range provided by the subject luminance to luminance in a luminance range provided by the target luminance.

3. The reception device according to claim 1, wherein
the luminance setting unit sets the subject luminance on a basis of luminance information of the video indicated by the service information.

4. The reception device according to claim 1, wherein
the luminance setting unit causes a storage unit to store the luminance adjustment information, and
the luminance adjustment unit adjusts the luminance of the video on a basis of the luminance adjustment information stored in the storage unit.

5. The reception device according to claim 1, wherein
when the video of the program is determined as the high dynamic range video, the display information output unit outputs luminance range information indicating that the luminance range of the video of the program is that of a high dynamic range video.

6. The reception device according to claim 1, further comprising
an application control unit that controls execution of processing specified by a predetermined application program on a basis of control information about control of service of the program, wherein
the application program causes a computer of the reception device to output the luminance setting screen and to set the target luminance.

7. A broadcasting system comprising:
a transmission device; and
a reception device, wherein
the transmission device transmits a program including a video, and service information of the program, and
the reception device includes
a display information output unit that, when a video of the program is determined as a high dynamic range video, which has a luminance range wider than a standard luminance range, on a basis of the service information, outputs a luminance setting screen which has an adjustment point related to predetermined subject luminance to be specified,
a luminance setting unit that sets target luminance of the adjustment point on a basis of an operation, and
a luminance adjustment unit that adjusts luminance of the adjustment point and luminance of the video on a basis of luminance adjustment information indicating the target luminance.

8. The broadcasting system according to claim 7, further comprising
a communication device that transmits a predetermined application program through communication in response to a request from the reception device, wherein
the reception device includes
an application control unit that controls execution of processing specified by the predetermined application program on a basis of control information about control of service of the program, and
the application program causes a computer of the reception device to output the luminance setting screen and to set the target luminance.
